(19) United States
(12) Patent Application Publication
(10) Pub. No.: US 2021/0114476 A1
(43) Pub. Date: Apr. 22, 2021

(54) SYSTEMS AND METHODS FOR AUTOMATIC CONNECTED CHARGER

(71) Applicant: Honda Motor Co., Ltd., Tokyo (JP)

(72) Inventor: Arjan Spaninks, Columbus, OH (US)

(21) Appl. No.: 16/659,929

(22) Filed: Oct. 22, 2019

(51) Int. Cl. B60L 53/36; B60L 53/18; B60L 53/16

(52) U.S. Cl. CPC B60L 53/36; B60L 53/16; B60L 53/18

(57) ABSTRACT

The systems and methods described herein are generally directed to automatic connected charging for a vehicle at a destination. According to one aspect, a system for automatic connected charging includes a position module, a connection module, and a charge module. The position module is configured to position a vehicle in charging alignment. The connection module is configured to release a charging cable having a charging port to connect the vehicle to a charging station and engage the charging port. The charge module is configured to initiate a charging function for the vehicle.

### BACKGROUND

With the transition to alternative fuel sources for vehicles, electric vehicles are becoming increasingly popular. Typically, the power for an electric vehicle is at least partially supplied from an on-board battery. As the car is driven, and the on-board battery is depleted, but can then be charged from remote power sources. For example, an electric vehicle may be electrically connected to an electrical grid to receive electrical energy that to be stored in the on-board battery for future use by the electric vehicle. In this manner vehicles may need to be repeatedly charged in order to operate.

### BRIEF DESCRIPTION

According to one aspect, a computer-implemented method for automatic connected charging is provided. The computer-implemented method includes positioning a vehicle in a charging alignment. The computer-implemented method also includes automatically releasing a charging cable having a charging port. The computer-implemented method further includes engaging the charging port to connect the vehicle to a charging station and initiating a charging function for the vehicle.

According to another aspect, a system for automatic connected charging includes a position module, a connection module, and a charge module. The position module is configured to position a vehicle in charging alignment. The connection module is configured to automatically release a charging cable having a charging port and engage the charging port to connect the vehicle to a charging station. The charge module is configured to initiate a charging function for the vehicle.

According to a further aspect, a non-transitory computer-readable storage medium stores instructions that, when executed by a computer, cause the computer to perform a method. The method includes positioning a vehicle in charging alignment. The method also includes automatically releasing a charging cable having a charging port. The method further includes engaging the charging port with the charging station to connect the vehicle to a charging station and initiating a charging function for the vehicle.

### BRIEF DESCRIPTION OF THE DRAWINGS

FIG. 1 is a schematic diagram of an operating environment for implementing systems and methods for automatic connected charging according to an exemplary embodiment.

FIG. 2 is a schematic diagram of an exemplary ceiling mount charging station for automatic connected charging according to an exemplary embodiment.

FIG. 3 is a schematic diagram of an exemplary ground mount charging station for automatic connected charging according to an exemplary embodiment.

FIG. 4 is a process flow diagram of a method for automatic connected charging according to an exemplary embodiment.

FIG. 5 is an illustration of an example computer-readable medium or computer-readable device including processor-executable instructions configured to embody one or more of the provisions set forth herein, according to one aspect.

### DETAILED DESCRIPTION

When charging vehicles, such as electric vehicles, are connected to an electrical grid to charge the on-board battery, vehicle operators have to perform the extra step of plugging in the charging vehicle after parking. Vehicle operators have found this extra step confusing and/or burdensome when compared to a traditional liquid fuel vehicle, such as a gasoline, petroleum, or diesel vehicle. Furthermore, range anxiety causes some vehicle operators feel compelled to check the status of charging.

Generally, the systems and methods disclosed herein are directed to automatic connected charging. Here, the vehicle positions in a charging alignment. For example, the vehicle may detect the proximity of a charging station and enter an auto-park mode that causes the vehicle to move to the charging alignment. When the vehicle achieves the charging alignment, a charging cable is released. The charging cable has charging port for connecting the vehicle to the charging station. Once the charging cable is released, the charging port is engaged to operatively connect the vehicle with the charging station such that the battery of the vehicle can be charged. In some embodiments, the charging port uses an electro-magnet to engage the vehicle and the charging station. For example, the electromagnet may be disposed on or within a mating port on the vehicle and/or ground. The electromagnet may also be disposed on or within the charging cable. The charging port may also utilize a pneumatic action or electronically controlled physical locking mechanism. Once the vehicle and the charging station are engaged, a charging function can be initiated without intervention by the vehicle operator. In fact, the vehicle may automatically achieve the charging alignment, plug-in the vehicle to a charging station, and begin charging the vehicle without intervention by the vehicle operator.

### Definitions

The following includes definitions of selected terms employed herein. The definitions include various examples and/or forms of components that fall within the scope of a term and that can be used for implementation. The examples are not intended to be limiting. Furthermore, the components discussed herein, can be combined, omitted, or organized with other components or into different architectures.

“Bus,” as used herein, refers to an interconnected architecture that is operably connected to other computer components inside a computer or between computers. The bus can transfer data between the computer components. The bus can be a memory bus, a memory processor, a peripheral bus, an external bus, a crossbar switch, and/or a local bus, among others. The bus can also be a vehicle bus that interconnects components inside a vehicle using protocols such as Media Oriented Systems Transport (MOST), Processor Area network (CAN), Local Interconnect network (LIN), among others.

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) can reside within a process and/or thread. A computer component can be localized on one computer and/or can be distributed between multiple computers.

“Computer communication,” as used herein, refers to a communication between two or more communicating devices (e.g., a vehicle charger, computer, personal digital assistant, cellular telephone, network device, vehicle, vehicle computing device, infrastructure device, roadside equipment) and can be, for example, a network transfer, a data transfer, a file transfer, an applet transfer, an email, a hypertext transfer protocol (HTTP) transfer, and so on. A computer communication can occur across any type of wired or wireless system and/or network having any type of configuration, for example, a local area network (LAN), a personal area network (PAN), a wireless personal area network (WPAN), a wireless network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), a vehicle-to-vehicle (V2V) network, a vehicle-to-everything (V2X) network, a vehicle-to-infrastructure (V2I) network, among others. Computer communication can utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Communication interface” as used herein can include input and/or output devices for receiving input and/or devices for outputting data. The input and/or output can be for controlling different vehicle features which include various vehicle components, systems, and subsystems. Specifically, the term “input device” includes, but it not limited to: keyboard, microphones, pointing and selection devices, cameras, imaging devices, video cards, displays, push buttons, rotary knobs, and the like. The term “input device” additionally includes graphical input controls that take place within a user interface which can be displayed by various types of mechanisms such as software and hardware-based controls, interfaces, touch screens, touch pads or plug and play devices. An “output device” includes, but is not limited to: display devices, and other devices for outputting information and functions. In one embodiment, the charging port may be an output device that controls the electricity used to charge the vehicle's battery.

“Computer-readable medium,” as used herein, refers to a non-transitory medium that stores instructions and/or data. A computer-readable medium can take forms, including, but not limited to, non-volatile media, and volatile media. Non-volatile media can include, for example, optical disks, magnetic disks, and so on. Volatile media can include, for example, semiconductor memories, dynamic memory, and so on. Common forms of a computer-readable medium can include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Database,” as used herein, is used to refer to a table. In other examples, “database” can be used to refer to a set of tables. In still other examples, “database” can refer to a set of data stores and methods for accessing and/or manipulating those data stores. A database can be stored, for example, at a disk, data store, and/or a memory. A database may be additionally or alternatively distributed among more than one computer and can be split onto more than one storage device or even held (partially or entirely) in volatile-memory to increase performance.

“Data store,” as used herein can be, for example, a magnetic disk drive, a solid-state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

“Display,” as used herein can include, but is not limited to, LED display panels, LCD display panels, CRT display, plasma display panels, touch screen displays, among others, that are often found in vehicles to display information about the vehicle. The display can receive input (e.g., touch input, keyboard input, input from various other input devices, etc.) from a user. The display can be accessible through various devices, for example, though a remote system. The display may also be physically located on a portable device, mobility device, or vehicle.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry can include and/or be a part of a processor controlled by an algorithm, a discrete logic (e.g., ASIC), an analog circuit, a digital circuit, a programmed logic device, a memory device containing instructions, and so on. Logic can include one or more gates, combinations of gates, or other circuit components. Where multiple logics are described, it can be possible to incorporate the multiple logics into one physical logic. Similarly, where a single logic is described, it can be possible to distribute that single logic between multiple physical logics.

“Memory,” as used herein can include volatile memory and/or nonvolatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory can store an operating system that controls or allocates resources of a computing device.

“Module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module can also include logic, a software-controlled microprocessor, a discrete logic circuit, an analog circuit, a digital circuit, a programmed logic device, a memory device containing executing instructions, logic gates, a combination of gates, and/or other circuit components. Multiple modules can be combined into one module and single modules can be distributed among multiple modules.

“Operable connection,” or a connection by which entities are “operably connected,” is one in which signals, physical communications, and/or logical communications can be sent and/or received. An operable connection can include a wireless interface, a physical interface, a data interface, and/or an electrical interface.

“Portable device,” as used herein, is a computing device typically having a display screen with user input (e.g., touch, keyboard) and a processor for computing. Portable devices include, but are not limited to, handheld devices, mobile devices, smart phones, laptops, tablets, e-readers, smart speakers. In some embodiments, a “portable device” could refer to a remote device that includes a processor for computing and/or a communication interface for receiving and transmitting data remotely.

“Processor,” as used herein, processes signals and performs general computing and arithmetic functions. Signals processed by the processor can include digital signals, data signals, computer instructions, processor instructions, messages, a bit, a bit stream, that can be received, transmitted and/or detected. Generally, the processor can be a variety of various processors including multiple single and multicore processors and co-processors and other multiple single and multicore processor and co-processor architectures. The processor can include logic circuitry to execute actions and/or algorithms.

“Vehicle,” as used herein, refers to any moving vehicle that is capable of carrying one or more users or cargo and is powered by any form of energy. The term “vehicle” includes, but is not limited to cars, trucks, vans, minivans, SUVs, motorcycles, scooters, boats, go-karts, amusement ride cars, rail transport, personal watercraft, and aircraft. In some cases, a motor vehicle includes one or more engines. Further, the term “vehicle” can refer to an electric vehicle (EV) that is capable of carrying one or more users and is powered entirely or partially by one or more electric motors powered by an electric battery. The EV can include battery electric vehicles (BEV), full hybrid electric vehicles (FHEV), fuel cell hybrid electric vehicles (FCHEV), and plug-in hybrid electric vehicles (PHEV). The term “vehicle” can also refer to an autonomous vehicle and/or self-driving vehicle powered by any form of energy. The autonomous vehicle can carry one or more users. Further, the term “vehicle” can include vehicles that are automated or non-automated with pre-determined paths or free-moving vehicles.

“Vehicle operator,” as used herein can include, but is not limited to, one or more biological beings operating the vehicle.

“Vehicle system,” as used herein can include, but is not limited to, any automatic or manual systems that can be used to enhance the vehicle, driving, and/or safety. Exemplary vehicle systems include, but are not limited to: an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a steering system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, an interior or exterior camera system, battery management system, among others.

### I. System Overview

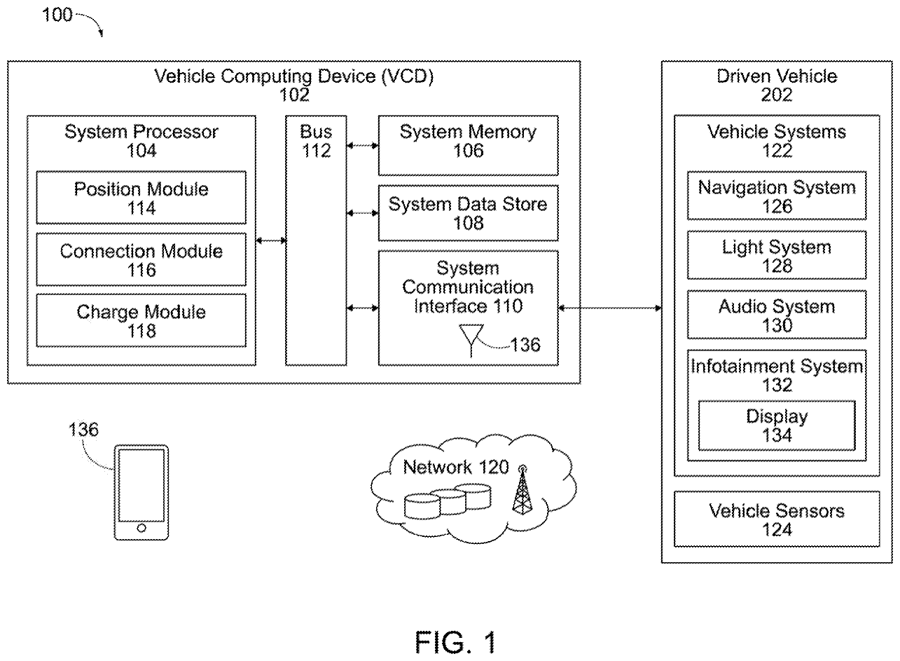

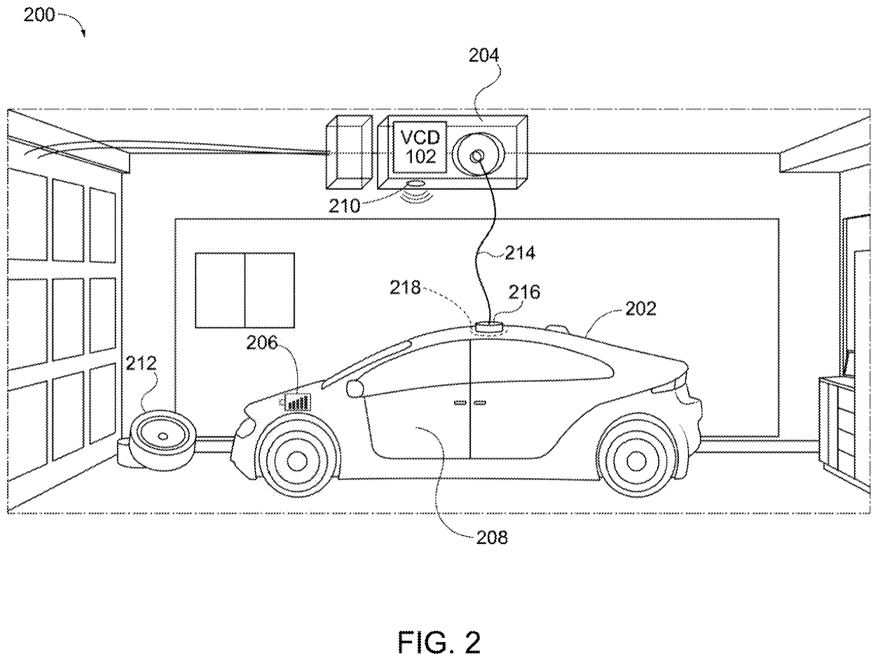

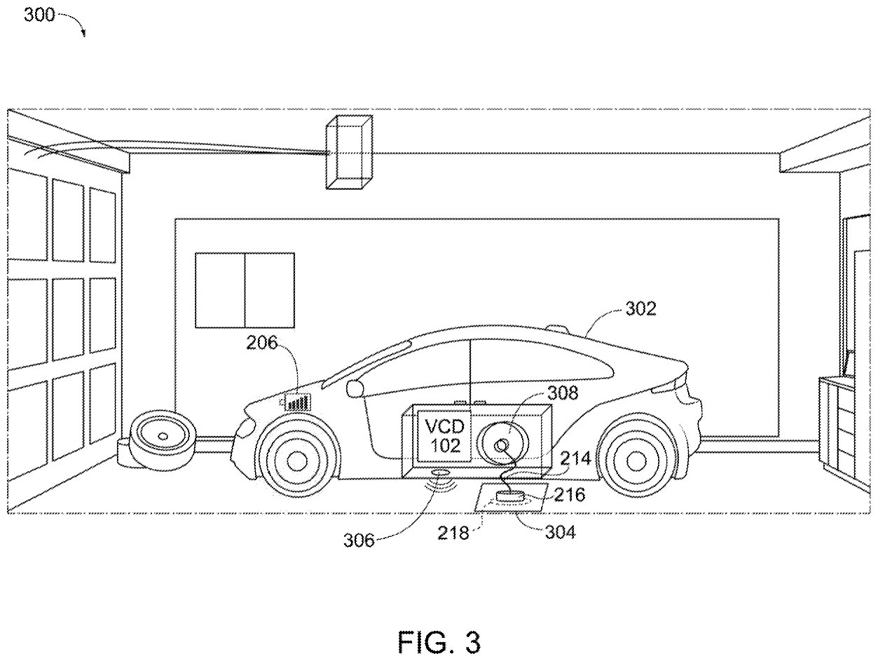

Referring now to the drawings, wherein the showings are for purposes of illustrating one or more exemplary embodiments and not for purposes of limiting same, FIG. 1 is a schematic diagram of an operating environment 100 for implementing systems and methods for automatically connected charging for a vehicle. The components of operating environment 100, as well as the components of other systems, hardware architectures, and software architectures discussed herein, can be combined, omitted, or organized into different architectures for various embodiments. Furthermore, the components of the operating environment 100 can be implemented with or associated with a vehicle. For example, FIG. 2 is a schematic diagram of a destination 200 and a vehicle 202 capable of automatic connected charging using a ceiling-mount charging station 204 according to an exemplary embodiment. FIG. 3 is a schematic diagram of a destination 300 and a vehicle 302 capable of automatic connected charging using a ground-mount charging station 304 according to an exemplary embodiment.

In the illustrated embodiment of FIG. 1, the operating environment 100 includes a vehicle computing device (VCD) 102 with provisions for processing, communicating and interacting with various components of a vehicle and other components of the operating environment 100. In one embodiment, the VCD 102 can be implemented with the vehicle, such as the vehicle 302 (shown in FIG. 3), for example, as part of a telematics unit, a head unit, a navigation unit, an infotainment unit, an electronic control unit, among others. In other embodiments, the components and functions of the VCD 102 can be implemented remotely from the vehicle, such as the vehicle 202 (shown in FIG. 2), for example, with a ceiling-mount charging station 204 or another device connected via a network (e.g., a network 120).

Generally, the VCD 102 includes a system processor 104, a system memory 106, a system data store 108, and a system communication interface 110, which are each operably connected for computer communication via a bus 112 and/or other wired and wireless technologies. The system communication interface 110 provides software and hardware to facilitate data input and output between the components of the VCD 102 and other components, networks, and data sources, which will be described herein. Additionally, the system processor 104 includes a position module 114, a connection module 116, and a charge module 118, each suitable for automatic connected charging facilitated by the components of the operating environment 100.

The VCD 102 is also operably connected for computer communication (e.g., via the system communication interface 110 and/or the bus 112) to one or more vehicle systems 122. The vehicle systems 122 can include, but are not limited to, any automatic or manual systems that can be used to enhance the vehicle, driving, and/or safety. The vehicle systems 122 include and/or are operably connected for computer communication to various vehicle sensors 124. The vehicle sensors 124 provide and/or sense information associated with one or more users, the vehicle 202, the vehicle environment, and/or the vehicle systems 122. The vehicle sensors 124 can include, but are not limited to, vehicle sensors 124 associated with the vehicle systems 122 and other vehicle sensors associated with the vehicle 202/302.

The VCD 102 is also operably connected for computer communication (e.g., via the bus 112 and/or the I/O interface 110) to one or more vehicle systems 122. Vehicle systems 122 can include, but are not limited to, any automatic or manual systems that can be used to enhance the vehicle, driving, and/or safety. It is understood that the vehicle systems 122 are exemplary in nature and other vehicle systems can be implemented with the systems and methods discussed herein.

Here, the vehicle systems 122 includes a navigation system 126 that calculates, and provides route and destination information and facilitates features like turn-by-turn directions. The vehicle systems 122 can include a light system 128 to control, for example, interior vehicle cabin lights (not shown) of the vehicle 202/302. Additionally, the light system 128 can perform a vehicle headlight and turn signal control for controlling lighting (e.g., head lights, flood lights) and signaling devices (e.g., turn signals, blind spot indicators) mounted on various locations of the vehicle 202/302, for example, front, side, rear, the top of the vehicle 202/302, the side mirrors, among others. The vehicle systems 122 can also include an audio system 130 that controls audio (e.g., audio content, volume) in the vehicle 202/302. Further, the vehicle systems 122 can include an infotainment system 132. The infotainment system 132 provides visual information and/or entertainment to the vehicle operator and can include a display 134.

Referring again to FIG. 1, and as mentioned above, the vehicle systems 122 include and/or are operably connected for computer communication to various vehicle sensors 124. The vehicle sensors 124 provide and/or sense information associated with one or more vehicle operators, the vehicle 202/302, the vehicle environment, and/or the vehicle systems 122. It is understood that the vehicle sensors can include, but are not limited to, the vehicle sensors 124 associated with the vehicle systems 122 and other vehicle sensors associated with the vehicle 202/302. Specific vehicle system sensors can include, but are not limited to, vehicle speed sensors, accelerator pedal sensors, brake sensors, throttle position sensors, wheel sensors, anti-lock brake sensors, camshaft sensors, among others. Other vehicle sensors can include, but are not limited to, cameras mounted to the interior or exterior of the vehicle 202/302 and radar and laser sensors mounted to the exterior of the vehicle 202/302.

Further, vehicle sensors 124 can include sensors external to the vehicle 202/302 (accessed, for example, via the network 120), for example, external cameras, radar and laser sensors on other vehicles in a vehicle-to-vehicle network, street cameras, surveillance cameras, among others. Additionally, the vehicle sensors 124 may include sensors that sense the vehicle 202/302 at the destination. For example, the position sensor 210 shown in FIG. 2 and/or the position sensor 306 shown in FIG. 3 may sense the position of vehicle 202 and 302 relative to the destination 200 and 300, respectively.

The vehicle sensors 124 are operable to sense a measurement of data associated with the vehicle, the vehicle environment, the vehicle systems 122, and/or operator of the vehicle, and generate a data signal indicating said measurement of data. These data signals can be converted into other data formats (e.g., numerical) and/or used by the vehicle systems 122 and/or the VCD 102 to generate other data metrics and parameters. It is understood that the sensors can be any type of sensor, for example, acoustic, electric, environmental, optical, imaging, light, pressure, force, thermal, temperature, proximity, among others.

The vehicle sensors 124 can also include, but are not limited to, cameras mounted to the interior or exterior of the vehicle 202/302 and radar and laser sensors mounted to the exterior of the vehicle 202/302. Further, the vehicle sensors 124 can include sensors external to the vehicle 202/302 (accessed, for example, via the network 120), such as external cameras, radar and laser-based sensors on other vehicles in a vehicle-to-vehicle network, street cameras, surveillance cameras, and roadway sensors, among others.

The VCD 102 is also operatively connected for computer communication to the network 120. For example, connections may be made through a network connection (e.g., wired or wireless), a cellular data network from a portable device 136 or a remote computing device (not shown), a vehicle to vehicle ad-hoc network (not shown), an in-vehicle network (not shown), among others, or any combination of thereof. The network 120 is, for example, a data network, the Internet, a wide area network or a local area network.

The network 120 serves as a communication medium to various remote devices (e.g., databases, web servers, remote servers, application servers, intermediary servers, client machines, other portable devices). In some embodiments, the network 120 may be accessed at the destination 200/300. The destination 200/300 may be any area where the vehicle 202/302 can be parked to access a charging station, such as the ceiling-mount charging station 204, shown in FIG. 2, or the ground-mount charging station 304, shown in FIG. 3. For example, a destination 200/300 may be places where vehicle operators live, work, play, and congregate that have a charging station capable of charging an on-board battery 206 of the vehicle 202/302.

### II. Methods for Providing Automatic Connected Charging

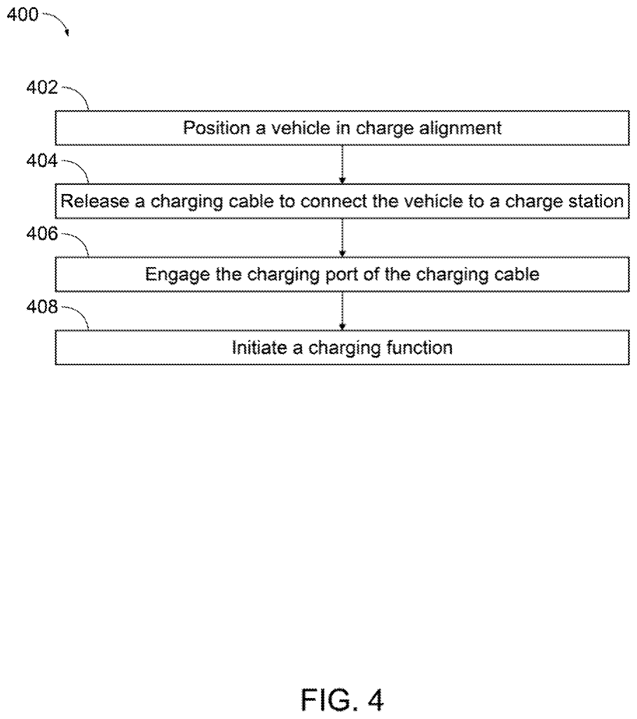

Referring now to FIG. 4, a method 400 for providing automatic connected charging will now be described according to an exemplary embodiment. FIG. 4 will be described with reference to FIGS. 1-3. The illustrative examples discussed herein are exemplary in nature and varying vehicles, destinations, and charging station arrangements may be implemented.

With reference to FIG. 4, at block 402 the method 400 includes positioning the vehicle 202 or 302 in a charging alignment at a destination 200 or 300, respectively. As described above, a destination may be residence shown in FIGS. 2 and 3. For example, the destination 200/300 is an area where the vehicle 202/302 is going to be parked, turned off, or remain stationery for a period of time. The charging alignment is the position that puts the vehicle 202/302 in a preferred position for charging. The position module 114 may additionally utilize other components of the operating environment 100, including vehicle systems 122 and the vehicle sensors 124. For example, the position sensor 210 may detect that the vehicle 202 has enter the destination. The position sensor 210, like the position sensor 306, may detect the location of the vehicle 202/302. For example, the position sensor 210/306 may detect the position of the vehicle 202/302 relative to the charging alignment. Accordingly, the position module 114 may utilize information from the position sensor 210/306 to determine the relative position of the vehicle 202 to the charging alignment.

The position module 114 may position the vehicle 202/302 in the charging alignment at the destination 200/300 based on a trigger event. For example, suppose the trigger event is opening the vehicle door 208 of the vehicle 202. If the vehicle operator opens the vehicle door 208 at the vehicle 202, the position module 114 may trigger the position module 114 to put the vehicle 202/302 in the charging alignment. Accordingly, the trigger event may be based on information from the vehicle systems 122 and/or vehicle sensors 124. Additionally or alternatively, the trigger event may be based on proximity. For example, the trigger event may be based on the proximity of the vehicle 202/302 to the destination 200/300, respectively. The trigger event may also be based on a remote device. For example, the vehicle occupant may send an instruction using the portable device 136 to position the vehicle 202/302 in the charging alignment.

In response to the triggering event, the position module 114 may generate or transmit a position plan. The position plan includes number of actions that will result in the vehicle 202/302 being positioned in the charging alignment. The actions may correspond to messages between the position module 114 and the vehicle 202/302. The actions may include longitudinal and lateral movements, trajectory, speed, coordinates, directions, etc. to achieve the charging alignment. In generating the position plan, the position module 114 may calculate the kinematic parameters needed to execute the action.

The position module 114 may additionally determine if assuming the charging alignment is appropriate given the current state of the destination 200/300. For example, suppose that the destination 200 has an obstacle 212 that blocks access to charging alignment. The position module 114 may generate a position plan may indicate an alternative charging alignment to avoid the obstacle 212.

In some embodiments, the position module 114 may use the vehicle systems 122 and the vehicle sensors 124. For example, the vehicle systems 122 can include autonomous driving systems, driver-assist systems, adaptive cruise control systems, lane departure warning systems, merge assist systems, freeway merging, exiting, and lane-change systems, collision warning systems, integrated vehicle-based safety systems, and automatic guided vehicle systems, auto-park systems, or any other advanced driving assistance systems (ADAS). Suppose that the VCD 102 is located remotely from the vehicle 202. The position module 114 may transmit the position plan to the vehicle 202. The vehicle 202 may employ vehicle system 122 to autonomously operate the vehicle 202 to assume the charging alignment. In another embodiment, the VCD may be located on board the vehicle 302, as shown in FIG. 3 and use the generated position plan to autonomously operate the vehicle 302 to assume the charging alignment.

Additionally or alternatively, the position module 114 may engage the vehicle systems 122 and the vehicle sensors 124 to provide cues to a vehicle operator (not shown) of the vehicle 202/302 so that the vehicle operator can position the vehicle 202/302 in the charging alignment. For example, the position module 114 may use the light system 128 to activate the turn signal control and signaling devices to indicate to the vehicle operator the direction that vehicle 202/302 should move to assume the charging alignment. Similarly, the position module 114 may engage the audio system 130 to provide audio cues and/or the infotainment system 132 to provide visual cues to the vehicle operator. In this manner, the vehicle systems 122 may also be used to facilitate the vehicle operator positioning the vehicle 202/302. Accordingly, the vehicle operator can execute the alignment steps to position the vehicle 202/302.

The position module 114 may detect and/or confirm that the vehicle 202/302 has achieved the charging alignment. For example the vehicle sensor 210/306 may compare the current location of the vehicle 202/302 to the charging alignment. In some embodiments, the position module 114 may determine whether the vehicle 202/302 is within a threshold distance of the charging alignment to detect whether the vehicle 202/302 has achieved the charging alignment. For example, the threshold distance may be a longitudinal distance, lateral distance, angular distance, or radial distance, among others. Furthermore, positioning may be based on the location of the charging-port 216 relative one or more pieces of vehicle geometry. For example, the position module 114 may include a number of instructions based on the current location of the vehicle 202/302 to the charging alignment based on the vehicle geometry given a number of predetermined axis such as X: 305 millimeters behind the passenger-side mirror, Y: 25 millimeters in front of the rear bumper, and Z: 1032 millimeters above the front-axle. Accordingly, known aspects of the vehicle 202/302 can be used by the position module 114 to achieve the charging alignment through vehicle autonomy and/or intervention by a vehicle operator.

Returning to FIG. 4, at block 404 the method 400 includes releasing a charging cable having a charging port to connect the vehicle 202/302 to a charging station. In response to the vehicle assuming the charging alignment, the connection module 116 causes a charging cable to be released. The charging cable 214 is an electrically conductive pathway. The charging cable 214 may be used for data or signaling to exchange information between the charger and the vehicle 202/302 to communicate information such as the state-of-charge, rate-of-charge, etc. The charging cable 202/302 may include twisted-pair wires, copper wires, etc. The charging cable 214 may be released from a charging station, such as the ceiling-mount charging station 204, or the vehicle, such as the vehicle 302. In some embodiments, releasing the charging cable 214 includes dropping the charging cable 214 from a first height to a second height below the first height.

The charging cable 214 has a first end and a second end longitudinally separated from the first end by the length of the charging cable 214. The first end of the charging cable 214 is attached to either the charging station, such as the ceiling-mount charging station 204, or the vehicle, such as the vehicle 302. The second end of the charging cable 214 is attached to the remainder of the charging station, such as the ceiling-mount charging station 204, or the vehicle, such as the vehicle 302. Accordingly, the charging cable 214 operatively couples the charging station and the vehicle. The operative coupling allows electrical energy to flow to charging station from the vehicle, and conversely, to the vehicle from the charging station.

Turning to FIG. 2, the charging cable 214 may be released from the ceiling-mount charging station 204. For example, connection module 116 may activate a motorized spool to release the charging cable 214. In another embodiment, the charging cable 214 may be retractable based on the design of the physical or electric properties of the charging cable 214. For example, the charging cable 214 may be telescopic or collapsible. The connection module 116 may be configured to release the charging cable 214 based on the physical or electric properties of the charging cable 214. With respect to FIG. 3, the charging cable 214 may be released from the vehicle 302. In a similar manner as the ceiling-mount charging station 204, the connection module 116 may activate a motorized spool 308 to release the charging cable 214 from the vehicle 302.

The connection module 116 may release the charging cable 214 in response to the vehicle 202/302 being positioned in the charging alignment. For example, the position module 114 may detect with the vehicle sensors 124, such as the position sensor 210/306 that the vehicle 202/302, respectively, is in the charging alignment. In response to the position module 114 determining that the vehicle 202/302 is in the charging alignment, the connection module 116 may cause the charging cable 214 to be released. In another embodiment, the connection module 116 may release the charging cable 214 in response to the trigger event being identified by position module 114.

Continuing the example from above, suppose that the triggering event is event is opening the vehicle door 208 of the vehicle 202. When the vehicle door 208 is opened the position module 114 may position the vehicle 202/302 in the charging alignment and/or the connection module 116 may release the charging cable 214. Therefore, the triggering event may trigger both the position module 114 and connection module 116 to operate.

With reference to FIG. 4, at block 406 the method 400 includes engaging the charging port 216 of the charging cable 214. The first end of the charging cable 214 may be permanently or removably attached to the charging station or the vehicle 202/302. The second end of the charging cable 214 is coupled to charging port 216. The charging port 216 is configured to electrically connect the charging station 204/304 and the vehicle 202/302 for charging. For example, the charging port 216 may be configured to dock with a mating port 218 on either the vehicle 202, as shown in FIG. 2, or the ground-mount charging station 304, as shown in FIG. 3.

In some embodiments, the charging alignment is defined by the location of the charging port 216 relative to the mating port 218. In particular, the charging alignment may be defined by an alignment axis that intersects the plane of the charging port 216 and the plane of the mating port 218. The alignment axis may also be orthogonal to the ground. Accordingly, having the vehicle 202/302 assume the charging alignment may define a shortest distance between the charging port 216 and the mating port 218 when the charging cable 214 is retracted. When the charging cable 214 is released the charging port 216 may drop to be directly over the mating port 218. For example, releasing the charging cable 214 may include dropping the charging cable 214 from a first height to a second height below the first height along the alignment axis.

In some embodiments, the charging port 216 may engage the mating port 218 in response to the charging cable being released. Additionally or alternatively, the charging port 216 and the mating port 218 may be employ electromagnets to engage one another. For example, the connection module 116 may apply a current to the charging port 216 to generate a magnetic field that attracts the charging port 216 to the mating port 218. In another embodiment, the connection module 116 may apply a current to the mating port 218 to generate a magnetic field that attracts the charging port 216 to the mating port 218.

With reference to FIG. 4, at block 408 the method 400 includes initiating a charging function when the vehicle 202/302 is electrically coupled to the charging stations, such as the ceiling-mount charging station 204 or the ground-mount charging station 304. The charge module 118 may initiate the charging function. The charging function may be to charge the vehicle 202/302, provide a charge to an electrical grid (not shown) from the vehicle 202/302, and determine a current status (e.g., current charge, time to full charge, charge rate, etc.) of the charge, among others. In some embodiments, the current status of the charge may be delivered to portable device 136.

Because the vehicle 202/302 can be moved into the charging alignment, the charging cable 214 released, and the charging port 216 engaged without intervention by a vehicle 202/302 to initiate a charging function can be initiated without intervention by the vehicle operator. Accordingly, in addition to automating arrival at the destination 200/300, the systems and methods described here provide automatic connected charging.

Although described in sequence, two or more of the position module 114, the connection module 116, and the charge module 118 may operate concurrently and/or in a different sequence. For example, the connection module 116 may release the charging cable 214 before the vehicle 202/302 is positioned in the charging alignment. In another embodiment, the charging port 216 may be able to engage the mating port 218 before the before the vehicle 202/302 is positioned in the charging alignment. In yet another embodiment, the charge module 118 may initiate the charge function in response to the position module 114 detecting the vehicle 202/302 is positioned in the charging alignment.

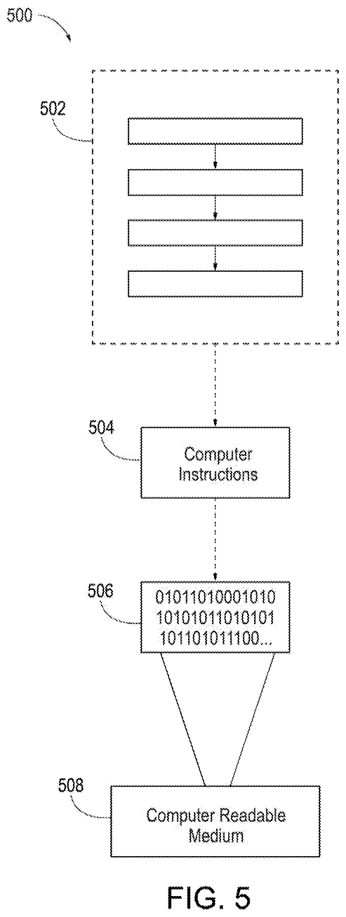

Still another aspect involves a computer-readable medium including processor-executable instructions configured to implement one aspect of the techniques presented herein. An aspect of a computer-readable medium or a computer-readable device devised in these ways is illustrated in FIG. 5, wherein an implementation 500 includes a computer-readable medium 508, such as a CD-R, DVD-R, flash drive, a platter of a hard disk drive, etc., on which is encoded computer-readable data 506. This encoded computer-readable data 506, such as binary data including a plurality of zero's and one's as shown in 506, in turn includes a set of processor-executable computer instructions 504 configured to operate according to one or more of the principles set forth herein. In this implementation 500, the processor-executable computer instructions 504 may be configured to perform a method 502, such as the method 400 of FIG. 4. In another aspect, the processor-executable computer instructions 504 may be configured to implement a system, such as the operating environment of FIG. 1 as it pertains to the arrangements of FIG. 2 and FIG. 3. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

The embodiments discussed herein may also be described and implemented in the context of computer-readable storage medium storing computer executable instructions. Computer-readable storage media includes computer storage media and communication media. For example, flash memory drives, digital versatile discs (DVDs), compact discs (CDs), floppy disks, and tape cassettes. Computer-readable storage media may include volatile and nonvolatile, removable and non-removable media implemented in any method or technology for storage of information such as computer readable instructions, data structures, modules or other data. Computer-readable storage media excludes non-transitory tangible media and propagated data signals.

1. A computer-implemented method for automatic connected charging, the method comprising:
positioning a vehicle in a charging alignment,
automatically releasing a charging cable operably connected to a charging port,
engaging the charging port to connect the vehicle to a charging station, and
initiating a charging function for the vehicle.

2. The computer-implemented method of claim 1, further comprising:
determining the vehicle is within a threshold distance of the charging alignment by comparing a current location of the vehicle to the charging alignment.

3. The computer-implemented method of claim 1, wherein positioning the vehicle in the charging alignment includes generating a position plan that includes number of actions that when executed by one or more vehicle systems causes the vehicle to be positioned in the charging alignment.

4. The computer-implemented method of claim 1, wherein the charging alignment is defined by an alignment axis that intersects a plane of the charging port and a plane of a mating port, and wherein the alignment axis is orthogonal to the ground.

5. The computer-implemented method of claim 4, wherein releasing the charging cable includes dropping the charging cable from a first height to a second height below the first height along the alignment axis.

6. The computer-implemented method of claim 1, wherein the positioning the vehicle and releasing the charging cable occur in response to a trigger event.

7. The computer-implemented method of claim 1, wherein the charging port engages a mating port by employing electromagnets.

8. A system for automatic connected charging for a vehicle, the system comprising:
a position module configured to position the vehicle in a charging alignment;
a connection module configured to automatically release a charging cable having a charging port and engage the charging port to connect the vehicle to a charging station; and
a charge module configured to initiate a charging function for the vehicle.

9. The system of claim 8, wherein the position module is further configured to determine the vehicle is within a threshold distance of the charging alignment by comparing a current location of the vehicle to the charging alignment.

10. The system of claim 8, wherein the charging alignment is defined by an alignment axis that intersects a plane of the charging port and a plane of a mating port, and wherein the alignment axis is orthogonal to the ground.

11. The system of claim 10, wherein the connection module is configured to release the charging cable by causing the charging cable to drop from a first height to a second height below the first height along the alignment axis.

12. The system of claim 8, wherein the charging port engages a mating port by employing electromagnets.

13. The system of claim 8, wherein the charging function includes the charge module determining a current status of a charge and delivering the current status to a portable device.

14. A non-transitory computer-readable storage medium storing instructions that, when executed by a computer, causes the computer to perform a method comprising:
positioning a vehicle in a charging alignment,
automatically releasing a charging cable having a charging port,
engaging the charging port to connect the vehicle to a charging station, and
initiating a charging function for the vehicle.

15. The non-transitory computer-readable storage medium of claim 14, further comprising:
determining the vehicle is within a threshold distance of the charging alignment by comparing a current location of the vehicle to the charging alignment.

16. The non-transitory computer-readable storage medium of claim 14, wherein positioning the vehicle in the charging alignment includes generating a position plan that includes number of actions that when executed by one or more vehicle systems causes the vehicle to be positioned in the charging alignment.

17. The non-transitory computer-readable storage medium of claim 14, wherein the charging alignment is defined by an alignment axis that intersects a plane of the charging port and a plane of a mating port, and wherein the alignment axis is orthogonal to the ground.

18. The non-transitory computer-readable storage medium of claim 17, wherein releasing the charging cable includes dropping the charging cable from a first height to a second height below the first height along the alignment axis.

19. The non-transitory computer-readable storage medium of claim 14, wherein the positioning the vehicle and releasing the charging cable occur in response to a trigger event.

20. The non-transitory computer-readable storage medium of claim 14, further comprises:
initiating the charging function by determining a current status of a charge; and
delivering the current status to a portable device.
